(19) United States
(12) Patent Application Publication
(10) Pub. No.: US 2013/0286653 A1
(43) Pub. Date: Oct. 31, 2013

(54) MULTI-BEAM LIGHT ENGINE

(71) Applicants: Robert L. Holman, San Jose, CA (US); Matt Sampsell, San Jose, CA (US)

(72) Inventors: Robert L. Holman, San Jose, CA (US); Matt Sampsell, San Jose, CA (US)

(73) Assignee: QUALCOMM MEMS TECHNOLOGIES, INC., San Diego, CA (US)

(21) Appl. No.: 13/459,489

(22) Filed: Apr. 30, 2012

(51) Int. Cl. F21V 9/00; F21V 5/04; B23P 11/00; F21V 7/00

(52) U.S. Cl. 362/293; 362/307; 362/311.01; 29/428

(57) ABSTRACT

This disclosure provides systems, methods, and apparatuses for a multi-beam light engine. In one aspect, a light source is coupled with an optical film such that light emitted from the light source passes through the optical film. The optical film can be a composite film including one or more sections, each of which is configured to operate differently on the input beam emitted from the light source. The optical film can be configured to produce one or more output beams of differing color, direction, and/or beam width.

### TECHNICAL FIELD

This disclosure relates generally to the field of illumination systems and luminaires, such as for large area lighting or architectural lighting.

### DESCRIPTION OF THE RELATED TECHNOLOGY

Conventional light fixtures used in various lighting applications can suffer from illumination inefficiencies, such as unwanted glare when looking upwards at the fixture's physical aperture and misdirected light that is wasted outside an area of interest. In addition, many light fixtures are limited to single applications.

### SUMMARY

The systems, methods and devices of the disclosure each have several innovative aspects, no single one of which is solely responsible for the desirable attributes disclosed herein.

One innovative aspect of the subject matter described in this disclosure can be implemented in an illumination system. The illumination system includes a narrow-angle light source configured to produce a narrow angle width input beam, and at least one optical film coupled to the light source. The optical film includes at least a first section configured to produce a first output beam and a second section configured to produce a second output beam. The first output beam is distinct from the second output beam in at least one of a beam width in a first meridian and a beam direction.

Another innovative aspect of the subject matter described herein can be implemented in a method for manufacturing an illumination system. The method includes providing a narrow-angle light source configured to produce a narrow angle width input beam, and disposing at least one optical film such that the input beam is directed towards the optical film. The optical film includes at least a first section configured to produce a first output beam and a second section configured to produce a second output beam. The first output beam is distinct from the second output beam in at least one of a beam width in a first meridian and a beam direction.

A further innovative aspect of the subject matter described herein can be implemented in an illumination system that includes means for producing a narrow angle width input beam, and at least one optical film coupled to the input beam-producing means. The optical film includes at least a first section configured to produce a first output beam and a second section configured to produce a second output beam. The first output beam is distinct from the second output beam in at least two of: beam direction, beam width in a first meridian, and color.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A is a cross-section perspective view of an implementation of a circular light guide that can be used to receive light from one or more centrally located light emitting diodes (LEDs).

FIGS. 1B and 1C illustrate cross-section perspective views of an implementation of a light engine including the circular light guide of FIG. 1A.

FIG. 1D illustrates an exploded schematic view of another implementation of a circular light guide plate with a light-turning film.

FIG. 2A illustrates a perspective view of an implementation of an illumination system including a light engine coupled with an optical film.

FIG. 2B illustrates a plan view of an implementation of a composite optical film.

FIG. 3A illustrates a perspective view of an implementation of an illumination system including a light engine coupled with a composite optical film.

FIG. 3B illustrates a perspective view of the optical film shown in FIG. 3A.

FIG. 3C illustrates an enlarged cross-section view of the optical film shown in FIGS. 3A and 3B.

FIG. 3D illustrates a far-field pattern provided by the optical film shown in FIGS. 3A-C.

FIG. 4A illustrates an enlarged cross-section view of another implementation of an illumination system.

FIG. 4B illustrates a far-field pattern provided by the illumination system shown in FIG. 4A.

FIGS. 4C and 4D illustrate enlarged cross-section views of additional implementations of an illumination system.

FIGS. 5A and 5B illustrate enlarged perspective views of one implementation of a stack of optical films.

FIG. 5C illustrates a far-field pattern provided by the stacked optical films shown in FIGS. 5A and 5B.

FIGS. 5D and 5E illustrate enlarged perspective views of another implementation of a stack of optical films.

FIG. 5F illustrates a far-field pattern provided by the stacked optical films shown in FIGS. 5D and 5E.

FIG. 6A illustrates an exploded perspective view of another implementation of an illumination system including a light engine and an optical film.

FIG. 6B illustrates an enlarged cross section view of the optical film shown in FIG. 6A.

FIG. 6C illustrates a schematic view of emitted light in an implementation of the illumination system shown in FIGS. 6A and 6B.

FIG. 7A illustrates a perspective view of another implementation of an illumination system including a light engine and an optical film.

FIG. 7B illustrates a schematic view of emitted light in an implementation of the illumination system shown in FIG. 7A.

FIG. 7C illustrates a schematic view of emitted light in another implementation of an illumination system.

FIG. 8A illustrates an exploded perspective view of an illumination system including a light engine and stacked optical films.

FIG. 8B illustrates a far-field pattern provided by the stacked optical films shown in FIG. 8A.

FIG. 9A illustrates a schematic perspective view of a three-part composite optical film, with enlarged detail cross-section views of portions of the optical film.

FIG. 9B illustrates a far-field pattern provided by the three-part composite optical film shown in FIG. 9A.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device or system that can be configured to provide illumination. More particularly, it is contemplated that the described implementations may be included in or associated with lighting used for a wide variety of applications such as, but not limited to: commercial, residential, automotive, avionic, as well as marine lighting. Implementations may include but are not limited to lighting in offices, schools, manufacturing facilities, retail locations, restaurants, clubs, hospitals and clinics, convention centers, hotels, libraries, museums, cultural institutions, government buildings, warehouses, military installations, research facilities, gymnasiums, sports arenas, backlighting for displays, signage, billboards, or lighting in other types environments or applications. In various implementations the lighting may be overhead lighting and may project downward a distance larger (for example, several times or many times larger) than the spatial extent of the lighting fixture. Thus, the teachings are not intended to be limited to the implementations depicted solely in the Figures, but instead have wide applicability as will be readily apparent to one having ordinary skill in the art.

In various implementations described herein, an optical film is coupled to a light source to enable the light emitted to have a variety of output beams that differ in shape, size, number, and pattern. In various implementations, the light engines can emit a narrow angle width beam. For example, at full-width half-maximum, portions of the beam emitted from the light engine can be contained within 30 degrees in at least one meridian. In some implementations, the light engine can include a light source, or one or more LEDs coupled with optics, or one or more LEDs coupled with optics as well as electrical and heat-management components. The light source may be a thin-profile light engine, which can include an LED and an elongated light guide into which the light from the LED is injected. The light is guided throughout the length of the light guide and is coupled out at different locations across the light guide such that the light can be output evenly from a large-area surface. One or more optical films may be disposed forward of the output aperture of the light engine to operate on the light emitted therefrom. In some implementations, the optical films can shape the light beams emitted from the light source. The optical film may be a sheet having a contoured surface, such as a surface with a plurality of grooves. In some implementations, the grooves form prismatic structures having sawtooth profiles. Light propagating through the contoured sheet can be, in different implementations, redirected by the surface contours by refraction or total internal reflection (“TIR”), or both. In some implementations, a plurality of different types of optical films having different functionalities can be stitched together into a composite film. A composite film can then include separate sections, which are non-overlapping regions of the composite optical film. In some embodiments, each section can include one films or a stack of films. Each section of the composite optical film can operate differently on a single input beam to produce differing output beams. For example, one section of the composite film can produce an output beam directed in one direction and another section can produce an output beam directed in another direction. The two beams may have different divergence angles. The two beams may also have different colors, shapes, and/or sizes in the far field.

Particular implementations of the subject matter described in this disclosure can be implemented to realize one or more of the following potential advantages. An optical film coupled to a light source as disclosed herein may create patterns such as shapes or graphics in the far field. Additionally, the optical film may be used to direct different light beams to more than one spatial location, for example, for spot lighting. Because superior control is enabled over the distribution and direction of light from a single light fixture, illumination efficiency for overhead lighting can thereby be improved. In some implementations, a single light source such as a light engine having a light emitter and a light guide coupled thereto are outfitted so as to receive interchangeable optical films. A user may therefore readily switch out different optical films for different applications, tailoring the characteristics of the emitted light to achieve the desired lighting scheme.

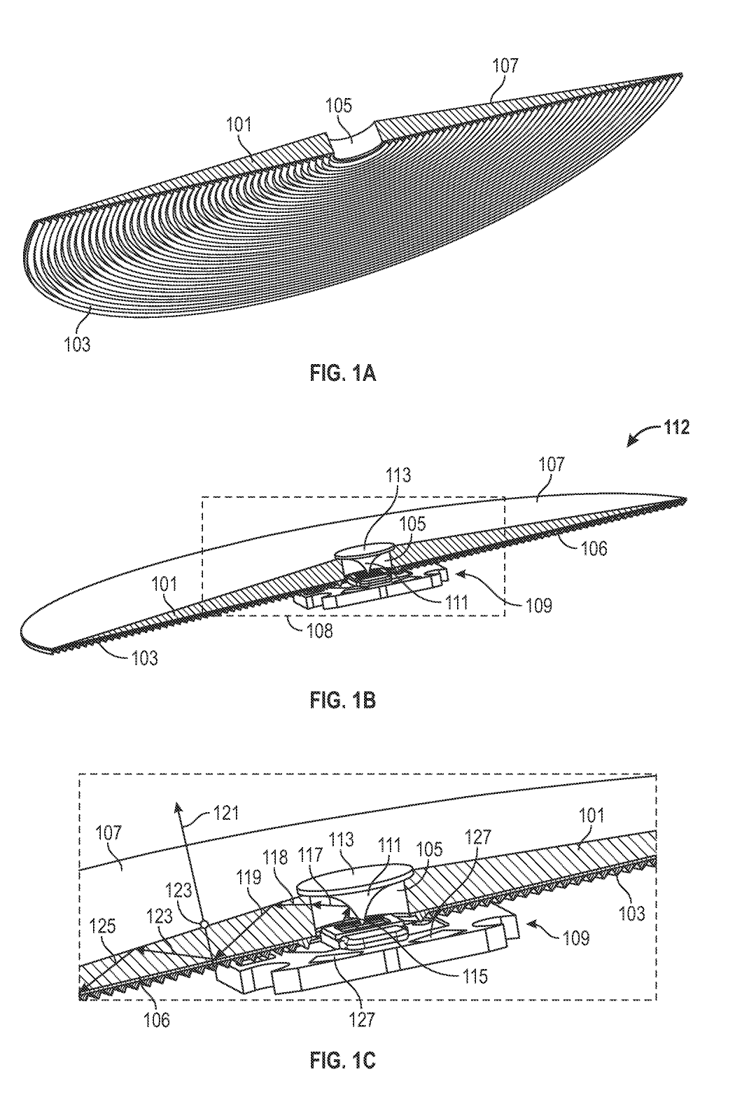

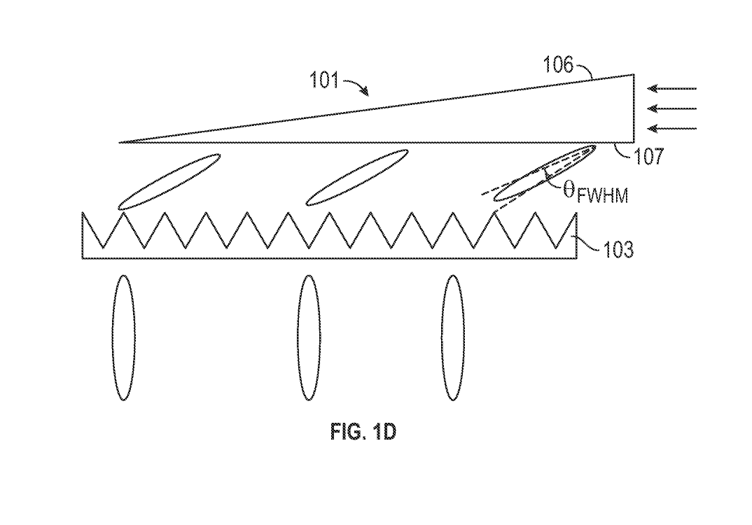

FIG. 1A is a cross-sectional perspective view of an implementation of a circular light guide 100. The circular light guide plate 101 has arranged over its rearward surface a faceted light-turning film 103. The thickness of the light guide plate 101 may decrease from the center towards the perimeter, creating a tapered profile. The light guide plate 101 also includes a central cylindrical surface 105 through which light can be injected into the light guide plate 101. Light entering the central boundary 105 propagates radially through the body of the light guide plate 101 by total internal reflection. In implementations where the light guide plate 101 is tapered, light guided in the light guide plate 101 will propagate by total internal reflection until it is ejected by the tapered light guide plate 101 at an oblique angle relative to the rearward surface 106 and/or the light guide plate 101. The obliquely ejected light can optionally interact with the light-turning film 103. In some implementations, the light ejected by the tapered light guide plate 101 can be a narrow beam having an angular width similar to the taper angle of the tapered plate 101. In some implementations, light-turning film 103 can turn the light so that center of the output beam is substantially normal to the rearward surface 106, the forward surface 107, and/or the light guide plate 101. Alternatively, the light-turning film 103 can be configured to turn the light so that the center of the output beam is at any angle relative to the forward surface 107. In some implementations, the light-turning film 103 can have a metalized surface so as to reflect light emitted from the light guide plate 101 such that the light is turned and output from through light guide plate 101 and emitted from the forward surface 107.

FIGS. 1B and 1C illustrate cross-sectional perspective views of an implementation of an LED emitter combined with the circular light guide plate 101 of FIG. 1A. FIG. 1C shows a magnified view 108 of the cross-section of FIG. 1B. As illustrated, an LED emitter assembly 109 and a radially symmetric reflector 111 are combined with the light guide plate 101 shown in FIG. 1A. Together this structure can comprise a light engine 112. The light emitter assembly 109 may include one or more light emitters such as light emitting diodes. Light emitted from LED emitter assembly 109 reflects off the curved surface 111 of a radially symmetric reflector 113. In some implementations, an etendue-preserving reflector may be used to couple light from the LED emitter assembly 109 to the light guide plate 101. Light entering the light guide plate 101 propagates therein by total internal reflection between rearward surface 106 and forward surface 107, until it is ejected by the tapered light guide plate 101 at an oblique angle relative to the rearward surface 106. For example, light ray 115 shown in FIG. 1C is redirected from the reflector 113 as ray 117 towards the cylindrical surface 105 of the light guide plate 101. On entry, example ray 117 is shown as propagating ray 118, which is reflected off the forward surface 107 of the light guide plate 101 as ray 119 and redirected back towards the rearward surface 106. Light that strikes the surface rearward surface 106 at less than the critical angle passes through rearward surface 106 towards light-turning film 103 and is turned out. Remaining light continues to propagate within the light guide plate 101 by total internal reflection as rays 123 and 125. As illustrated in FIGS. 1A-1C, the light-turning film 103 is arranged under the rearward surface 106 of the light guide plate 101 and is reflective to direct the light out of the forward surface 107.

FIG. 1D illustrates an exploded schematic view of a cross section of another implementation of a circular light guide plate with a light-turning film. As illustrated, the light-turning film 103 is arranged over the forward surface 107 of the light guide plate 101. In this configuration, light enters the light guide 101 from the right side and propagates through the light guide plate 101 as described above. In some implementations, the rearward surface 106 can be metalized so as to prohibit light from being emitted through the rearward surface 106. Light propagates within light guide plate 101 until emitted from forward surface 107 at an oblique angle relative to the forward surface 107. Light emitted from forward surface 107 can interact with light-turning film 103. As illustrated, the light-turning film 103 turns the light such that it exits the light-turning film 103 substantially perpendicular to the light guide plate 101 and the forward surface 107 of the light guide plate 101. The light-turning film 103, in the illustrated implementation, does not substantially affect the angular beam width of the light, for example, the light-turning film 103 does not affect the full width at half maximum of the beam, θ_{FWHM}. Rather, the light-turning film 103 redirects incident light from the circular light guide plate 103. The prism-like features of the light-turning film 103 need not be symmetric, and are shown as symmetric for illustrative purposes only. Although illustrated as turning light to be perpendicular to the forward surface 107, in other implementations the light-turning film 103 can be configured to turn the light at any angle relative to the forward surface 107. Moreover, the light-turning film 103 need not be uniform. For example, one portion may turn light at a first angle, with a second portion turning light at a second angle.

As shown, the light guide plate 101 is tapered such that its thickness decreases radially from the central portion to the peripheral portions. The tapering of the light guide plate 101 further assists light to be turned towards light-turning film 103, and output from the surface 107 of the light guide plate 101. In some implementations, the light guide plate 101 can be sloped from its central portion to its peripheral portions at an angle of about 5 degrees or less. In some implementations, the light guide plate 101 can be sloped at an angle between 1 to 10 degrees. In some implementations, the angle can range from 2 to 7 degrees. The slope of the light guide plate 101 can be related to the width of the light beam exiting the light guide plate 101. In some implementations where narrower beams are preferred, the light beam emitted from the forward surface 107 has a beam width, for example, θ_{FWHM}=60 degrees or less, 45 degrees or less, 30 degrees or less, 15 degrees or less, 10 degrees or less, or 5 degrees or less. In other implementations where wider beams are preferred, the light beam emitted from the forward surface 107 has a beam width, for example, θ_{FWHM}=120 degrees or less or 90 degrees or less. In some implementations where the slope of the light guide plate would be too large to be practical in order to achieve a desired output beam width, the light guide plate 101 may include one or more steps with regions of the light guide plate being sloped as desired rather than the whole light guide plate 101 having one continuous slope as illustrated. In some implementations, the light-turning film 103 or the light guide plate 101 and the light turning film 103 together can be configured to affect angular width of light distribution in addition to only turning the light without affecting the beam width. The configuration of light extraction features can assist in controlling the direction and distribution of light output from the light guide plate 101.

In some implementations, light emitted from LED emitter 109 can be evenly distributed across the surface of the light guide 100. In some implementations, light exiting the light guide 100 is substantially collimated. Additionally, brightness of the source is decreased because the light is distributed across a larger area.

In some implementations, the reflector 113 can be replaced by other functionally similar coupling optics, including segmented reflectors, a lens, groups of lenses, a light pipe section, hologram, etc. As shown, the LED emitter(s) emits light in response to a DC operating voltage applied to terminals 127. In some implementations, the LED emitter assembly 109 may have a different form of light-emitting surface, such as a raised phosphor, raised clear encapsulent, etc.

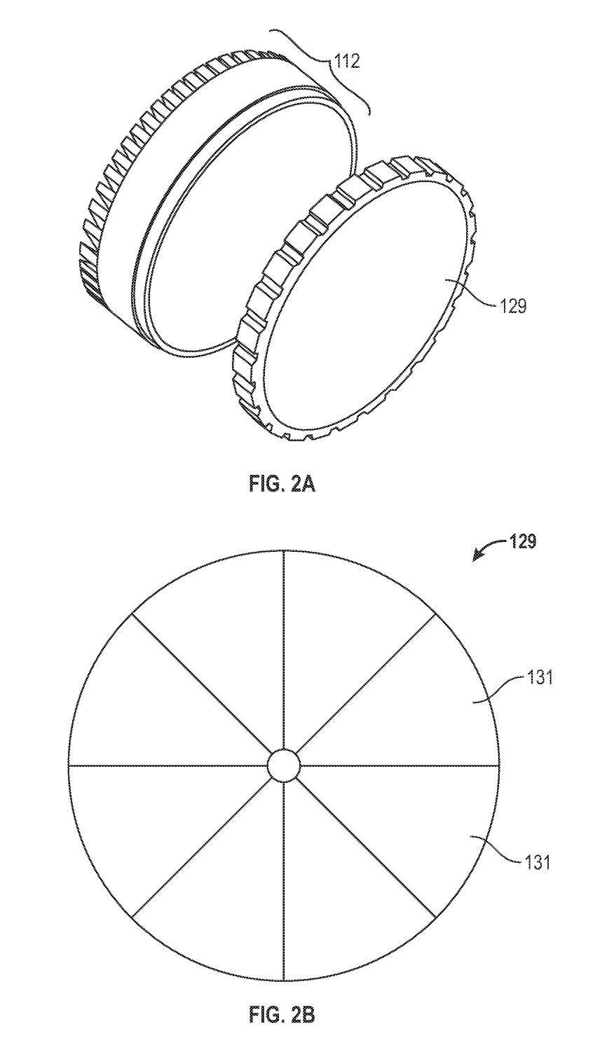

FIG. 2A illustrates a perspective view of an implementation of an illumination system including a light engine coupled with an optical film. As illustrated, an optical film 129 may be disposed forward the light engine 112. In various implementations, the optical film 129 can include an optical film, a stack of optical films, a composite optical film, or any combination thereof. In the illustrated configuration, light emitted from the light engine 112 constitutes an input beam directed through the optical film 129. The optical film 129 can be configured to modify the light in a variety of ways, including the color, beam width, and direction of the emitted light. One or more output beams exit the optical film 129 with characteristics that may differ from those of the input beam, depending on the design of the optical film 129. In various implementations, the optical films 129 can include lenslet arrays, lenticular films, lenticular-like films, diffusers (for example, surface or volume diffusers), color filters, clear windows, and cutouts. For example, optical film 129 may include a color filter, such that the output beam is characterized by a different color than that of the input beam. The optical film 129 can be removably coupled to the light engine 112. This can allow for easily changing between various different optical films 129, each of which can produce different composite output beams. Accordingly, various different optical films 129 can be used with a single light engine to produce differing illumination characteristics. For example, in some implementations the optical film 129 can be mounted onto an annular cap configured to fit over the front side of the light engine 112. Screws or other fastening mechanisms can be used to secure the annular cap to the light engine 112.

FIG. 2B illustrates a planar top view of an implementation of a composite optical film. As shown, the optical accessory 129 may include one or more optical films, each of which may include multiple sections 131, each of which operates differently on the input beam from the light engine 112. Each section 131 constitutes a non-overlapping area of the light optical film 129. In some implementations, these sections may be stitched, welded, or otherwise joined together to create a composite optical film 129, wherein each section has been formed by embossing, molding, or other conventional forming method, where each master forming tool has been configured for the performance desired. In some implementations, a single optical film 129 can be produced that includes a plurality of separate sections 131. For example, an optical film 129 can be formed by embossing, molding, or other conventional methods, in which the master forming tool is configured to include different sections with different features. These different sections of the master can correspond to the sections 131 of the optical film. Accordingly, an optical film 129 that includes multiple sections 131 can be formed integrally, rather than being stitched together from separately formed sections 131. In some implementations, the different sections 131 can be oriented in a “pie-chart” orientation, as illustrated in FIG. 2B. In other implementations, different configurations and orientations may be used. The sections 131 can take a multitude of shapes and orientations. Additionally, the number of individual sections 131 can range from one to many. For example, in some implementations, the optical film 129 can include two, three, four, or more sections. In other implementations, the optical film can include 10, 20, 30 or more sections. Each section can be configured to operate differently on the input beam. In some implementations, there may be two or more sections that operate on the input beam in similar or identical manners. In other implementations, each section can affect the input beam in a different way.

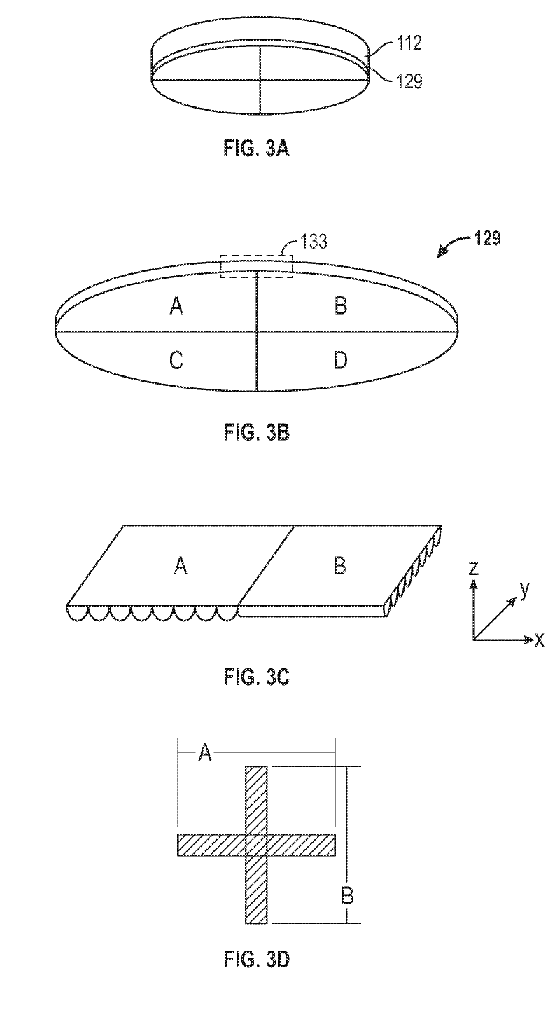

FIG. 3A illustrates a perspective view of an implementation of an illumination system including a light engine coupled with a composite optical film. As discussed above, an input beam emitted from the light engine 112 passes through the optical film 129, resulting in one or more output beams. FIG. 3B illustrates a perspective view of the optical film shown in FIG. 3A. As shown, the optical film 129 includes four separate sections: A, B, C and D. In various implementations, the optical film 129 can include more or less sections.

FIG. 3C illustrates an enlarged cross-section view of a portion the optical film shown in FIGS. 3A and 3B. In particular, FIG. 3C shows a magnified view of a portion 133 of the optical film 129. In the illustrated cross-section, two sections A and B of the optical film 129 are shown. First and second sections A and B are each lenticular-like films that modify incident light to provide an output beam that differs from the input beam emitted by the light engine 112. Classically, lenticular films include films that form an array of closely spaced semi-cylinder-like features, where all the semi-cylindrical features or lenticules are substantially the same. The term “lenticular-like” is intended to expand and to further include, but not be limited to, lenslet (for example, active in two or more meridinal planes), triangular, prismatic, semi-cylindrical-, sinusoidal-, parabolic-, and/or hyperbolic-like elements capable of spreading an input beam in one or more meridians. In various implementations, lenticular-like films can include elements that share the same optical shape and/or size, or elements that have different optical shapes and/or sizes. In various implementations, lenticular-like films can be with optical power or without optical power.

A lenticular-like film can be characterized by the meridinal plane in which it operates to spread light. The meridian is a Cartesian plane formed by two orthogonal axes, e.g., x and y, z and x, or any other combination of orthogonal Cartesian axes, that includes the meridinal arc. For example, the meridinal plane of the lenticular-like film of the first section A in FIG. 3C is oriented along the x-z plane. The meridinal plane of the lenticular-like film of the second section B in FIG. 3C is oriented along the y-z plane. Lenticular-like films can operate to spread light in the meridinal plane. Accordingly, the first section A of the optical film 129 spreads the input beam from the light engine out along the x-z plane. The second section B of the optical film 129 spreads the input beam from the light engine out along the y-z plane. The curvature of the lenticules is related to the amount of spreading.

FIG. 3D illustrates a far-field pattern provided by the optical film shown in FIGS. 3A-C. The far-field pattern consists of two elongated lines. The horizontal line corresponds to the light passing through the first section A. As noted above, the lenticular-like film of section A spreads light along the x-z plane, resulting in a far-field pattern of a line oriented in the x-direction. Similarly, the vertical line shown in FIG. 3D corresponds to the light passing through the second section B. As the lenticular-like film of second section B spreads light along the y-z plane, the far-field pattern produced is a line oriented in the y-direction. The result of the two-section optical film can therefore be a cross pattern in the far field. Variations on this approach can be employed to achieve a number of different output beams having different beam widths, directions, and/or far-field patterns. For example, in some implementations, the sections A and B in the film could be designed such that the far-field pattern includes two lines intersecting, but not at their respective centers. In some implementations, the sections A and B in the film could be designed such that the far-field pattern includes two lines intersecting substantially at their respective centers. In some implementations, the sections A and B in the film could be designed such that the far-field pattern includes two lines intersecting substantially at the center of one line, but not at the center of the other.

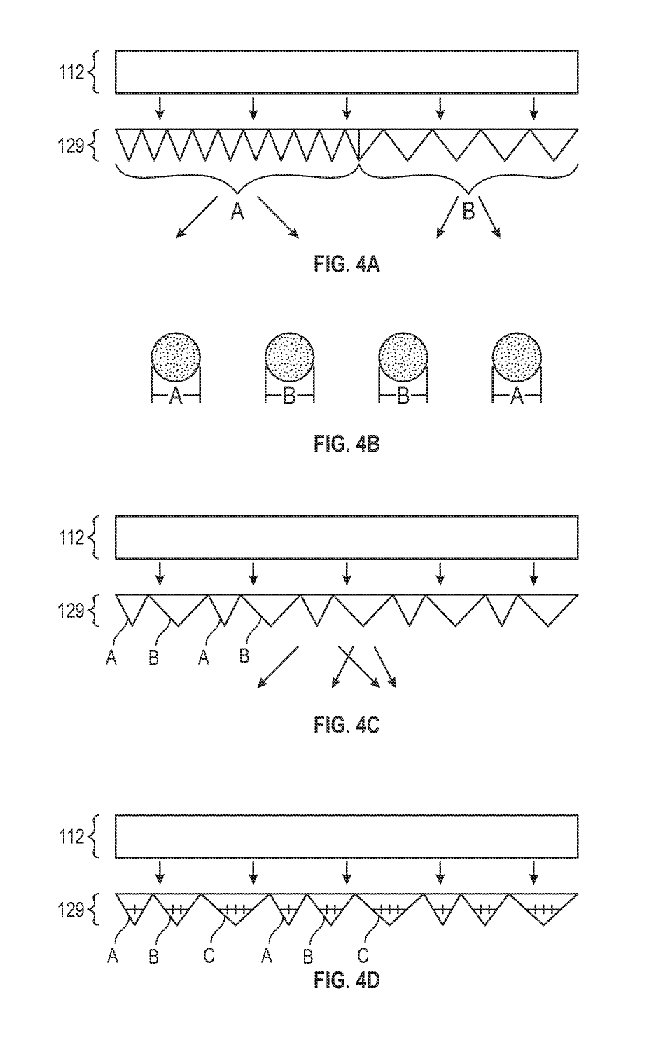

FIG. 4A illustrates an enlarged cross-section view of another implementation of an illumination system. A light guide 112 is shown providing an input beam to an optical film 129, in the illustrated implementation, a lenticular-like film. The optical film 129, as illustrated, includes a first section A and a second section B. These two sections each include prismatic features having triangular cross-sections. Such triangular features operate as beam-splitters, with the angle of the features determining the angles at which portions of the output beam are directed. For example, light incident on the first section A in FIG. 4A is split into two beams, with one directed leftward and one rightward relative to the input beam. The same is true of light incident on the second section B in FIG. 4A. In the illustrated implementation, the turning features of the first section A are more steeply angled than the turning features of the second section B and the first section A therefore splits the input beam wider than the second section B. FIG. 4B illustrates a far-field pattern provided by the illumination system shown in FIG. 4A. As shown, the two outermost circles correspond to the first section A, due to the larger beam-splitting effect. The two innermost circles correspond to the second section B, due to the relatively lesser beam-splitting effect.

FIGS. 4C and 4D illustrate enlarged cross-section views of additional implementations of an illumination system. As illustrated in FIG. 4A, the optical film 129 includes a first section A and a second section B, although additional sections are possible. In some implementations, each section of the optical film can cover an area of the optical film 129 equal to a fraction of about one over the number of different sections, where each section is configured to result in a far-field beam characteristic different from the far-field beam characteristic of the other sections. Hence, for example, an optical film 129 with three different sections may have about one third of its surface covered by each different section. In other implementations, one or more of the sections cover a greater portion of the surface of the optical film 129 that at least one other section. The far-field beam characteristic can include one or more of a beam width in a first meridian, a beam direction, and a beam color. Although FIG. 4A illustrates the first section A and the second section B as limited to separate halves of the optical film 129, other configurations are possible. For example, as shown in FIG. 4C, the more steeply angled turning features of section A can be interspersed with the less steeply angled turning features of section B. The resulting output beam is similar, having outermost circles (or other shapes depending on the geometry of the light engine and the optical film) that correspond to the first section A, and innermost circles (or other shapes) corresponding to the second section B. In FIG. 4D, a further variation is provided, in which a third section C includes even less steeply angled turning features. This would result in innermost circles (or other shapes) corresponding to the third section C, that would be positioned inside of the circles (or other shapes) corresponding to the second section B. Depending on the relative angles of the turning features and the distance from the illumination system to the area being illuminated, the different circles (or other shapes) can overlap in space. Accordingly, by varying the angular orientation of the turning features of the different sections of the optical film 129, various patterns can be provided. For example, having a plurality of sections, each with slightly different angled turning features, can produce an elongated strip, a composite of a series of circles (or other shapes) caused by the beam-splitting effect of each of the sections of the optical film 129. The beam-splitting effect illustrated herein can be adjusted in various ways and/or combined with other types of films to achieve the desired results.

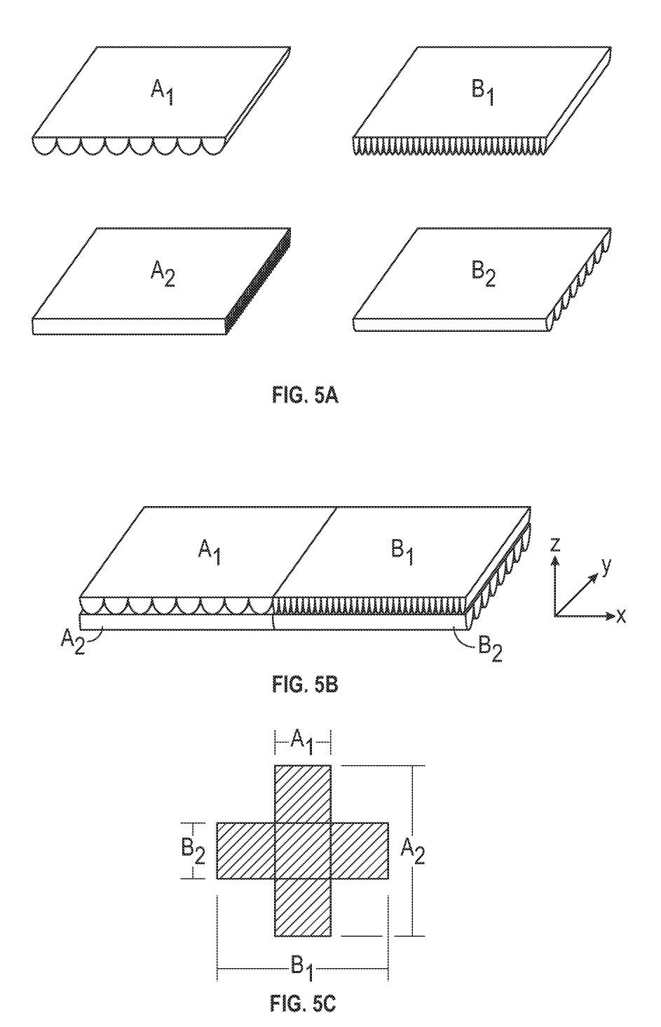

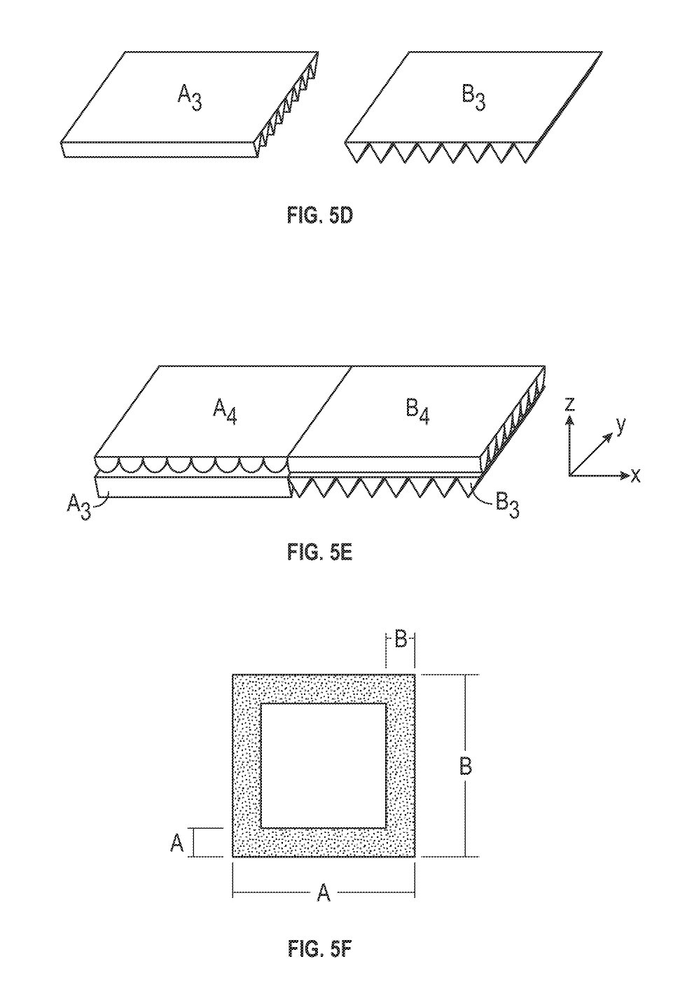

FIGS. 5A and 5B illustrate enlarged perspective views of one implementation of a stack of optical films. As illustrated, four separate films are shown: A1, A2, B1, and B2. As shown in FIG. 5B, A1 and A2 are stacked on top of one another, together forming part of a first section of a composite optical film 129. Similarly, B1 and B2 are stacked on top of one another, together forming part of a second section of a composite optical film 129. Both A1 and A2 are lenticular-like films, with A1 configured to operate in the meridian plane such that light is spread along the x-z plane, and A2 configured to operate in the meridian plane such that light is spread along the y-z plane. A1 and A2 may both include, for example, semi-cylindrical (elongated lenses with semi-circular cross section) or elongated lenses with parabolic cross section or other aspheric cross section. However, as illustrated, the optical power of the lenticules in A1 differs from the optical power of lenticules in B1. As illustrated, the lenticules in A1 and B2 are semi-cylindrical, whereas the lenticules in A2 and B1 are parabolic in cross section. As the curvature of lenticules increases, the spreading effect increases. Accordingly, the lenticular-like film B1 spreads light further in the x-z plane than the lenticular-like film A1. Both A2 and B2 are also lenticular-like films. However, as illustrated, they are oriented so as to spread light in the y-z plane, perpendicular to that of the lenticular-like films A1 and B1. The curvature of the lenticules differs between A2 and B2, such that A2 operates to spread light further in the y-z plane than the lenticules in B2.

FIG. 5C illustrates a far-field pattern provided by the stacked optical films shown in FIGS. 5A and 5B. The result is a cross-like pattern, whose dimensions are determined by the light-spreading function of the different lenticular-like films A1, A2, B1, and B2. As will be understood, the far-field pattern is determined both the shape of the input beam as well as the effect of the optical films through which the input beam passes. Together, the lenticular-like films A1 and A2 form the vertical bar of the cross. The lenticules in A1 spread light laterally, and therefore A1 determines the width of the vertical bar of the cross. The lenticules in A2 spread light orthogonal to that, such that A2 determines the height of the vertical bar of the cross. A similar effect is achieved by the stack of lenticular-like films B1 and B2, which together create the horizontal bar of the cross. The laterally spreading lenticules of B1 determine the width of the horizontal bar of the cross, while the vertically spreading lenticules of B2 determine the height of the horizontal bar of the cross. Accordingly, each of the relative dimensions can be controlled independently of the others by varying the curvature, shape, and/or orientation of the lenticular-like films A1, A2, B1, or B2.

FIGS. 5D and 5E illustrate enlarged perspective views of another implementation of a stack of optical films. As shown in FIG. 5D, two additional films A3 and B3 are illustrated. These include lenticular-like elements having a triangular cross-section. As described above with respect to FIGS. 4A-C, these elements can operate as beam-splitters. When stacked with other lenticular-like films A4 and B4, together the stacks can create various far-field patterns. The optical film A3 is oriented to split an input beam along the y-axis, whereas the optical film B3 is oriented to split an input beam along the x-axis.

FIG. 5F illustrates a far-field pattern provided by the stacked optical films shown in FIGS. 5D and 5E. The optical film A4 spreads light along the x-axis, while the optical film B4 spreads light along the y-axis. The operation of films A4 and B4 alone would produce a cross pattern, similar to that illustrated in FIG. 3D. In conjunction with the beam-splitting films A3 and B3, this cross pattern is divided along each axis, resulting in a rectangular perimeter pattern. The length of each of the top and bottom horizontal bars are determined by the spreading attributable to optical film A4 (the thickness of the bars being attributable to the unchanged beam width of the light engine, since, as illustrated, nothing has been done to change the beam width in the meridian of the thickness of the top and bottom bars, the y-z meridian), and the distances between the top and bottom bars is determined by the beam-splitting function of optical film A3. Similarly, the length of the two vertical bars is determined by the spreading attributable to the optical film B4 (the thickness of the bars being attributable to the unchanged beam width of the light engine as described above), whereas the distance between the vertical bars is determined by the beam-splitting function of optical film B3. By combining these four optical films, a rectangular frame pattern can be created in the far-field. These principles can be applied more broadly, such that by varying the orientation and design of the various optical films, a wide variety of patterns can be created in the far-field.

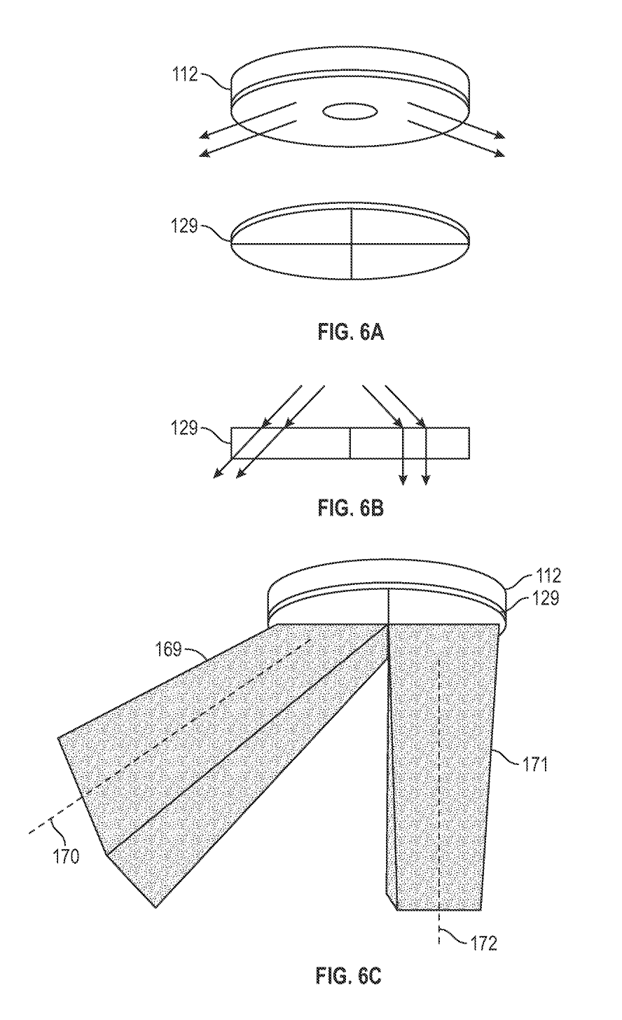

FIG. 6A illustrates an exploded perspective view of another implementation of an illumination system including a light engine and an optical film. In some implementations, as discussed above, the light engine 112 can be a narrow-angle light source, and can emit light substantially orthogonal to the emitting surface of the light engine 112. In other implementations, however, the light engine 112 can be configured to emit light more laterally, as illustrated in FIG. 6A. As shown, most light is emitted from the light engine 112 at a shallow angle. The optical film 129 is illustrated as exploded from the light engine 112 for clarity. FIG. 6B illustrates an enlarged cross section view of the optical film shown in FIG. 6A. As shown, the section of the optical film on the left does not affect the direction of the output beam. For example, the section of the optical film on the left may include a clear window, cut out, or a mild diffuser. As such, light passing through this section continues along its path determined by the input beam, here at a shallow angle relative to the surface of the optical film 129. The other illustrated section in FIG. 6B turns light from the input beam such that the output beam is substantially orthogonal to the surface of the optical film 129. Myriad variations on these sections are possible. For example, each can redirect light to different directions. This directionality can be also be combined with beam spreading, as described above with respect to FIGS. 5A-5E, beam-splitting as described above with respect to FIGS. 4A-4C, diffusion, and/or with color filtering.

FIG. 6C illustrates a schematic view of emitted light in an implementation of the illumination system shown in FIGS. 6A and 6B. As shown in FIG. 6C, a first output beam 169 is emitted from the one section of the composite optical film 129, with a second output beam 171 emitted from another section of the composite optical film 129. Only light emitted from two sections of the optical film 129 are shown. However, the principles explained here can be increased to include two, three, four, or more sections. In the illustrated implementation, the first and second output beams 169 and 171 differ at least in beam orientation. Such implementations where the beams differ in beam orientation can be useful in applications where a single light is to both provide light downward to illuminate a hallway, and to provide light towards a wall to illuminate a wall or something displayed on a wall. In FIG. 6C the beam direction is indicated by the direction of the center line through each beam. For example, the center line 170 through first output beam 169 corresponds to the beam direction of the first output beam, while the center line 172 through second output beam 171 corresponds to the beam direction of the second output beam. By varying the properties of the sections of the optical film 129, as discussed above, the output beams from each section can be varied. As a result, a single input beam provided by the light engine 112 can be used to generate multiple different output beams. As noted, the first and second output beams 169 and 171 in FIG. 6C differ only in beam direction, as indicated by their non-parallel (here diverging) center lines 170 and 172. However, the design of the optical film 129 can be used to control various characteristics of the output beam. For example, as shown in FIG. 6C, the first and second output beams 169 and 171 can be different colors or intensities. The different sections may for example include material that filters light. One section may include a darker filter than another section. Or one section can include a color absorber of a first color and another section can include a color absorber of a second color. In some implementations, for example, different color absorbing dyes may be include in the different sections. Some sections may have more absorbing material such as absorbing dye than other sections to provide variation in intensity. In some implementations, dichroic filters can be used to provide color filtering. In some implementations, dyed plastic sheets can be employed for color filtering.

As illustrated in FIG. 6C, the first and second output beams 169 and 171 can have different beam widths. For example, the second output beam 171 can have a narrower beam width than the first output beam 169. Each of these characteristics (direction, intensity, color, and width) can be controlled independently. Accordingly, the output beams can vary only in one of these characteristics, or they may differ in two or more. Other parameters of the output beams may also be controlled as desired (for example, polarization).

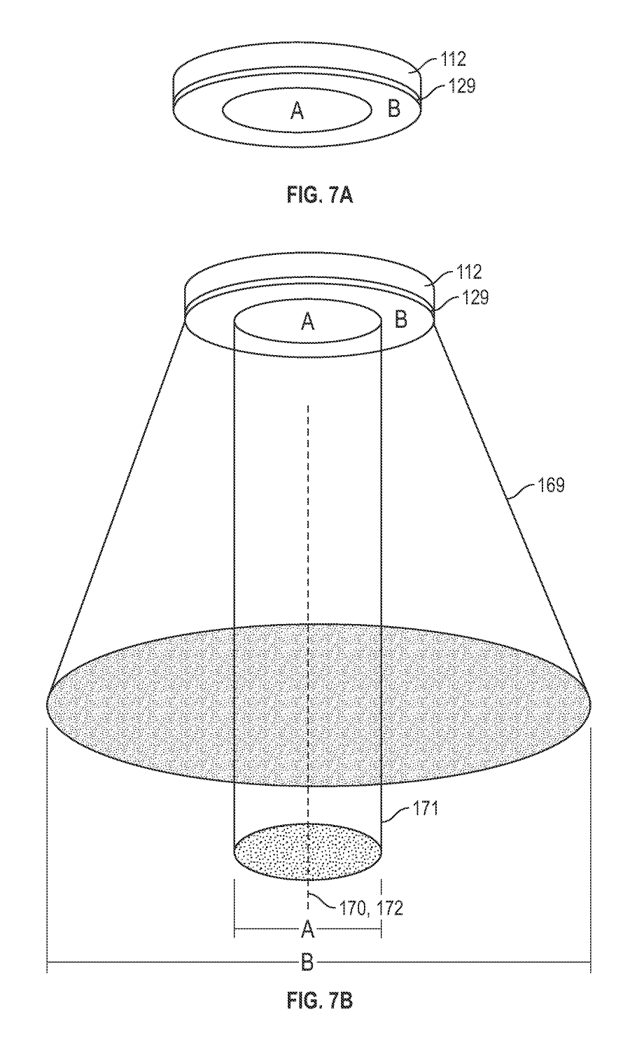

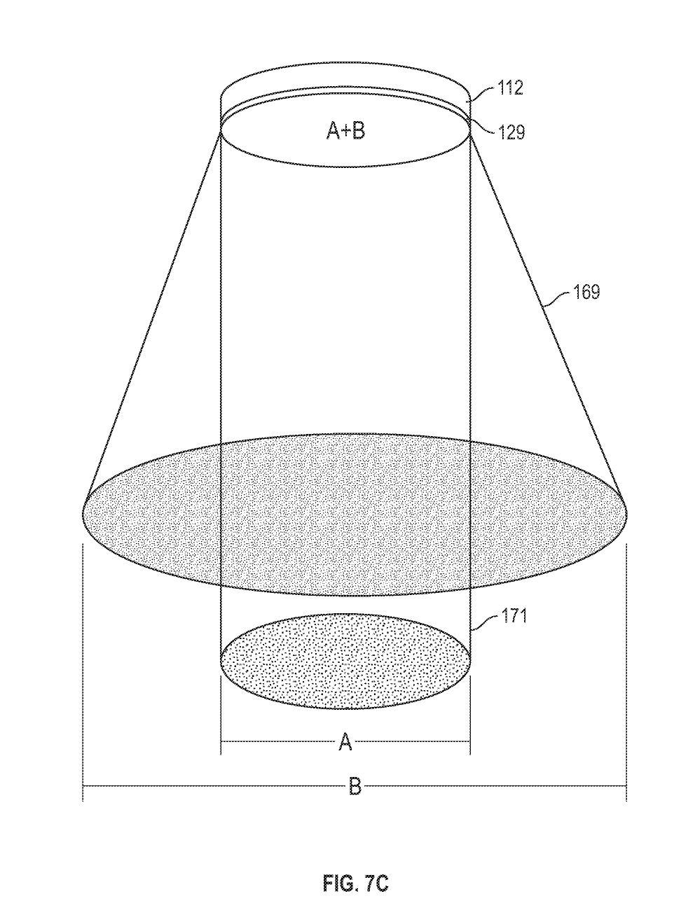

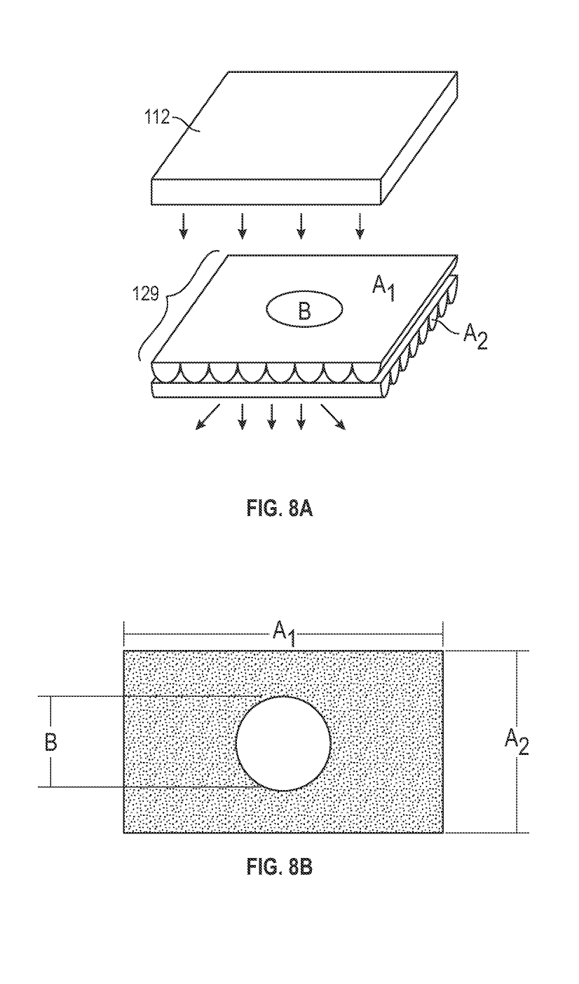

FIG. 7A illustrates a perspective view of another implementation of an illumination system including a light engine 112 coupled to an optical film 129. FIG. 7B illustrates a schematic view of emitted light in an implementation of the illumination system shown in FIG. 7A. Although the composite optical film 129 has been previously described as including pie-like sections, other configurations may be employed. As will be understood, these examples are illustrative only, and numerous other configurations are possible. The different sections of the composite optical film 129 can be arranged in any manner desired to produce a given series of output beams. For example, as shown in FIG. 6A, a first section A of the optical film 129 can be circumscribed by a second section B. The first section A produces an output beam 171 by operating on an input beam from the light engine 112. In the illustrated example, the output beam 171 has a relatively narrow beam width. For example, this could be accomplished by using an optical film 129 in section A that includes a clear or tinted window, a cut out, a mild diffuser, or an array of lenslets with low optical power. In contrast, the second section B produces an output beam 169 with a relatively wide beam width. For example, the relatively wide beam width may be accomplished using an optical film 129 in section B that includes a relatively moderate to heavy diffuser or an array of lenslets with relatively high optical power. As illustrated, the first output beam 169 and the second output beam 171 have the same beam direction, as indicated by their shared center lines 170 and 172. In some implementations, the two output beams may also vary in color. By controlling these parameters of the different output beams, various patterns can be generated in the far-field, as described in more detail herein.

FIG. 7C illustrates a schematic view of emitted light in another implementation of an illumination system. While the output pattern is similar to that shown in FIG. 7B, in the illustrated implementation of FIG. 7C the two sections A and B are interspersed, rather than restrained to separate physical portions of the optical film 129. For example, the first section A can include a plurality of lenses or lenslets configured to produce a relatively narrow output beam, while the second section B can include a plurality of lenses or lenslets configured to produce a relatively wide output beam, where the lenses or lenslets of varying optical power are interdispersed throughout the optical film 129. In some implementations lenses or lenslets in sections A and B are radially symmetric and are not elongated in the x- or y-dimension as are some of the illustrated lenticule implementations, and hence are capable of producing the circular beams illustrated in FIG. 7C. These two types of lenses can be distributed evenly across the entire surface of the optical film 129. The result, as illustrated in FIG. 7C, is a narrower output beam having dimensions determined by the first section A, and a wide output beam having dimensions determined by the second section B. In other implementations, the two beams of varying width can be formed using regions of varying diffusive power interdispersed throughout the optical film 129.

FIG. 8A illustrates an exploded perspective view of an illumination system including a light engine and stacked optical films. The illumination system includes a light engine 112 and a composite optical film 129. As illustrated, the optical film 129 includes a stack of lenticular-like films A1 and A2, and section B circumscribed by the optical films A1 and A2. In various implementations, section B may simply include a window or cutout of optical films A1 and A2, or section B may include an optical film with relatively low optical power lenses or relatively mild diffusers to produce a circular output beam. Together the stack of lenticular-like films A1 and A2 constitute the first section, while the section B can constitute the second section of the composite optical film 129. It is understood that in film A1, section B may simply be a window or cut out (simply allows incident light to pass without refraction), while film A2 may include a section the corresponds to section B that includes a window or cut out, or alternatively, an array of relatively low optical power (compared to the beam spreading power of films A1 and A2) lenses or lenslets or a relatively mild diffuser (compared to the beam spreading power of films A1 and A2).

FIG. 8B illustrates a far-field pattern provided by the stacked optical films shown in FIG. 8A. The stack of lenticular-like films A1 and A2 can operate as described above to spread light in orthogonal directions to create a rectangular pattern. Accordingly, the width of the rectangle corresponds to the spreading function of the lenticules in the optical film A1, and the height of the rectangle corresponds to the spreading function of the lenticules in the optical film A2. As illustrated, the section B includes an optical film that provides a color filter, and may or may not affect the direction or width of the input beam. Accordingly, the section B corresponds to the circle positioned in the center of the rectangular pattern of FIG. 8B, where the size of the circle corresponds to the optical function of section B. The lenticular-like films A1 and A2 can likewise employ color filtering to produce a desired effect or may have no color filter. As noted elsewhere herein, the orientation and design of the various optical films can be varied to achieve the desired effect. In particular the beam width, direction, intensity, and color can be independently controlled with respect to each section of the optical film 129. By combining the output beams of several different sections, myriad far-field patterns can be achieved.

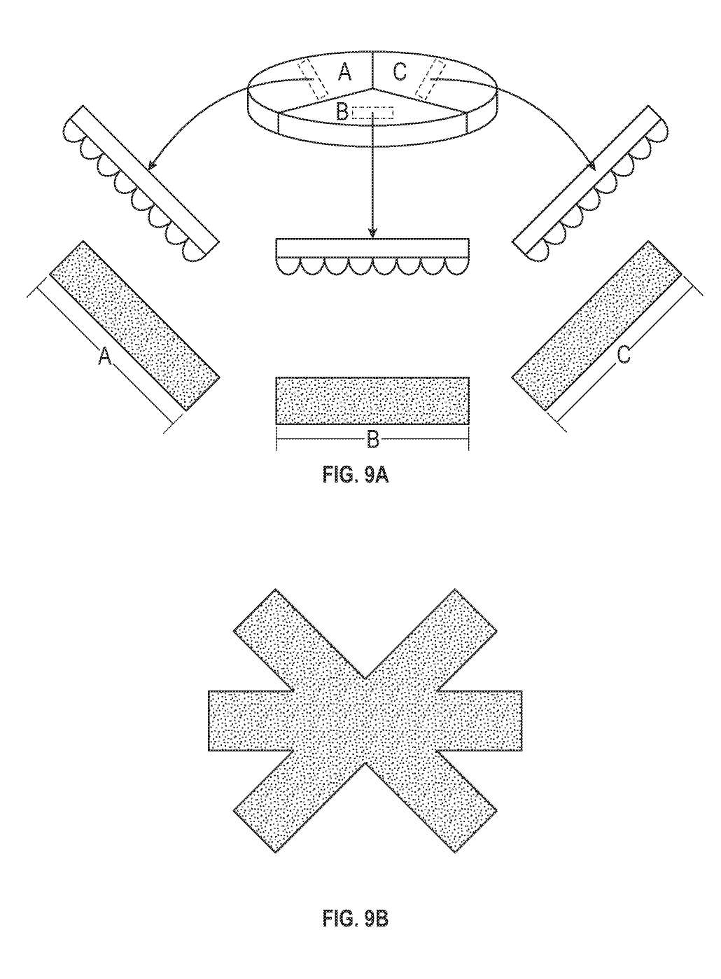

FIG. 9A illustrates a schematic perspective view of a three-part composite optical film, with enlarged detail cross-section views of portions of the optical film. Here the composite film includes three sections: A, B, and C. Each section includes a lenticular-like film, as illustrated in the cross-section views. Each of the lenticular-like films A, B, and C includes convex semi-cylindrical lenticules of similar configurations. However, the orientation of the lenticules varies between the three sections, such that the lenticular-like film A operates to spread light along one plane, while the lenticular-like film C operates to spread light in a nearly orthogonal plane. The lenticular-like film B operates to spread light in a plane in between that of lenticular-like film A and lenticular-like film C. Each of the three sections therefore produces an elongated line. FIG. 9B illustrates a far-field pattern provided by the three-part composite optical film shown in FIG. 9A. When combined, the three output beams corresponding to sections A, B, and C of the optical film 129 create an asterisk-like pattern in the far-field. As illustrated, in various implementations, the composite optical film can be formed of different sections such that light emitted from each section is superimposed at least partially on each other. A wide range of other beams shapes, arrangements, and far field patterns may be realized by configuring the thin film differently. For example, in some implementations, the sections A, B, and C in the film could be designed such that the far-field pattern includes three lines intersecting, but not at their respective centers. In some implementations, the sections A, B, and C in the film could be designed such that the far-field pattern includes three lines intersecting substantially at their respective centers. In some implementations, the sections A, B, and C in the film can be designed such that the far-field pattern includes three lines intersecting at one or two of their respective centers, while not intersecting the center of the other of the lines. In some implementations, the far-field pattern may include three lines that do not intersect at all.

Using the concepts discussed herein, implementations of an optical film may create patterns such as graphics or images in the far field. In some implementations, the optical film may be used to direct light to more than one spatial location, for example, for spot lighting. Because superior control is enabled over the distribution and direction of light from a light fixture by passing light with narrow angle width beam through lenticular-like optical films, utilization efficiency for overhead lighting can thereby be improved. As used herein, utilization efficiency refers to the portion of light that is directed to the field sought to be illuminated. With the superior control enable in the implementations described herein, most or nearly all of the light can be directed to any number of fields of interest. In some implementations, a light source such as a light engine having a light emitter and a light guide coupled thereto are outfitted so as to receive optical films, and configured such that a user can readily switch out different optical films for different applications. The optical films may be between 25 μm and 3 mm thick, and can have a surface area ranging from 1 in² and 16 ft².

Additionally, two or more optical films can be stacked on top of one another to produce different output beams. In this implementation, the two or more optical films overlap with one another such that a ray of light passes through each of the optical films in the stack to form part of an output beam. For example, a first optical film can include sections that affect the color of the output beams, while a second optical film can include sections that affect the direction or beam width of the output beams. In other implementations, three or more optical films can be stacked on top of another to produce a desired illumination pattern. As will be understood, various configurations are possible. By varying the structure and orientation of the individual sections of an optical film, as well as varying the number and configuration of different optical films stacked on top of one another, many permutations are possible, allowing for a wide range of output beams to be achieved.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the illumination system as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An illumination system comprising:
a light source configured to produce an input beam; and
at least one optical film coupled to the light source so as to receive the input beam such that the input beam is directed towards the at least one optical film, the at least one optical film including at least a first section configured to produce a first output beam and a second section configured to produce a second output beam,
wherein the first output beam is distinct from the second output beam in at least one of a beam width in a first meridian and a beam direction.

2. The illumination system of claim 1, wherein the first and second output beams are each directed to a direction different than the input beam, or the first and second output beams each have a beam width different than the input beam.

3. The illumination system of claim 1, wherein the input beam has a full-width at half-maximum of less than 30 degrees in at least one meridian.

4. The illumination system of claim 1, wherein the light source includes a tapered light guide.

5. The illumination source of claim 1, wherein the light source includes an etendue-preserving reflector.

6. The illumination system of claim 1, wherein the at least one optical film includes a lenticular-like film.

7. The illumination system of claim 1, wherein the at least one optical film further includes a stack of lenticular-like films.

8. The illumination system of claim 8, wherein the stack of lenticular films include a first lenticular-like film and a second lenticular-like film, where the first lenticular-like film acts on light in a first meridian and the second lenticular-like film acts on light in a second meridian.

9. The illumination system of claim 1, wherein the first section includes a first plurality of lenticules or lenslets having one optical function and the second section includes a second plurality of lenticules or lenslets having a different optical function, and wherein the first and second plurality of lenticules or lenslets are interdispersed.

10. The illumination system of claim 1, wherein the first section includes a first plurality of lenticules having one optical function and the second section includes a second plurality of lenticules having a different optical function, and wherein the first and second plurality of lenticules are not interdispersed.

11. The illumination system of claim 1, wherein the first section is configured to direct the first output beam in a first direction and the second section is configured to direct the second output beam in a second direction different than the first direction.

12. The illumination system of claim 1, wherein the first section is configured to produce an output beam having a first beam width and the second section is configured to produce a second output beam with a second beam width different than the first beam width.

13. The illumination system of claim 1, wherein the first section includes a color filter of a first color and the second section includes one of: no color filter and a color filter of a second color different than the first color.

14. The illumination system of claim 1, wherein the first section is configured to cause the first output beam to have a first shape in the far field and the second section is configured to cause the second output beam to have a second different shape in the far field.

15. The illumination system of claim 1, wherein the first section is configured to cause the first output beam to have a far field beam pattern that is rectangular.

16. The illumination system of claim 1, wherein the optical film is configured to provide a far-field pattern including one or more shapes selected from: a rectangle, a square, a triangle, an asterisk, and a cross.

17. The illumination system of claim 1, wherein the at least one optical film further includes a third section configured to produce a third output beam, wherein the third output beam the third output beam is directed to a different direction than each of the first and second output beams, or the third output beam has a different beam width than each of the first and second output beams.

18. The illumination system of claim 17, wherein the at least one optical film further includes a fourth section configured to produce a fourth output beam, wherein the fourth output beam is directed to a different direction than each of the first, second, and third output beams, or the fourth output beam has a different beam width than each of the first, second, and third output beams.

19. A method for manufacturing an illumination system, the method comprising:
providing a light source configured to produce an input beam; and
disposing at least one optical film such that the input beam is directed towards the optical film, the at least one optical film including at least a first section configured to produce a first output beam and a second section configured to produce a second output beam,
wherein the first output beam is distinct from the second output beam in at least one of a beam width in a first meridian and a beam direction.

20. The method of claim 19, wherein the first and second output beams are each directed to a direction different than the input beam, or the first and second output beams each have a beam width different in a first meridian than the input beam.

21. The method of claim 19, wherein providing the light source includes providing a tapered light guide.

22. The method of claim 19, wherein the first section is configured to direct the first output beam in a first direction and the second section is configured to direct the second output beam in a second direction different than the first direction.

23. The method of claim 19, wherein the first section is configured to produce an output beam having a first beam width and the second section is configured to produce a second output beam with a second beam width different than the first beam width.

24. An illumination system comprising:
means for producing an input beam; and
beam-altering means for altering one of: a beam width in a first meridian, a beam direction, or a color of the input beam, the beam-altering means coupled to the beam-producing means so as to receive the input beam such that the input beam is directed towards the beam-altering means, the beam-altering means including at least a first section configured to produce a first output beam and a second section configured to produce a second output beam,
wherein the first output beam is distinct from the second output beam in at least one of the beam width in the first meridian and the beam direction.

25. The illumination system of claim 24, wherein the beam-producing means includes a light engine, or wherein the beam-altering means includes an optical film.
